(19) United States
(12) Patent Application Publication
(10) Pub. No.: US 2005/0221751 A1
(43) Pub. Date: Oct. 6, 2005

(54) Apparatus and process for fish and small game processing

(76) Inventor: Darryl Lawson, Fallon, NV (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/815,989

(22) Filed: Mar. 31, 2004

(51) Int. Cl. A22C 18/00

(52) U.S. Cl. 452/195

(57) ABSTRACT

A filleting apparatus and process depending spends a fish and/or small game by the tail or legs along an inclined supporting surface. A fillet board having a supporting surface is elongated along a major axis has the supporting surface extending across the length of the fillet board parallel to a minor axis of the fillet board taken normal to the major axis of the fillet board. A loop is mounted at one of the fillet board approximate the major axis for suspending a fish by the tail or small game by the feet or head. Apparatus supports the fillet board with the supporting surface upwardly exposed and the major axis in an inclined disposition. The loop is at the upper end of the inclined fillet board, the supported fillet board having the fish and/or small game supporting surface horizontally disposed relative to the minor axis when the fillet board is in the inclined disposition.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

This invention relates to an apparatus and process for filleting fish and/or processing small game. More particularly, a fillet board is mounted to an inclined side of an A-frame and provides for the pendulous suspension of fish to be filleted or small game to be processed in a notch supported looped rope from the top of the angularly inclined board.

### BACKGROUND OF THE INVENTION

Boards for filleting fish are well-known. In usual case, such boards are always horizontal and provide for fixing of the fish to the board during the filleting process by grooves, shelves, and/or indentations. See for example Lord et al. U.S. Design Pat. No. (DES) 308,792, Burd DES 352,427 and Stachowiak U.S. Pat. No. 4,485,527. Tables for filleting are also known as set forth in Cybula DES 348,993.

It is well known that in the past the process of cleaning, skinning, scaling, filleting fish and similarly processing small game that there are many problems associated with the operation.

While cleaning fish in the outdoors on the river or lake, many times the anglers choose to clean there fish on the bank near the water in order to preserve the quality of the meat as soon as possible after the fish has been caught. This usually involves bending over or kneeling on the bank of the river in the water where they are constantly fighting the waves in the water as boaters go by, trying to avoid getting the fish fillets contaminated with the sand gravel, and other debris on the riverbank.

The flat fillet boards that are in use today are not much help because they must be placed on the ground or a slippery rock where the user still must kneel down to reach it as well as fight the splashing waves and continually try to hold the fillet board with one hand while trying to fillet the fish with the other. This is very back breaking work especially after a long day of fishing or hunting.

Discovery

In the wild (for instance in a gravel covered riverbank) conventional horizontal filleting equipment is unsuitable. I have discovered the need for a filleting apparatus and process suitable for use by a standing adult at the site of the catch or elsewhere. Further, reliance upon securing of the body of the fish either by clamps at the tail of the fish and/or grooves or indentations within a filleting board is inherently unstable and even dangerous during processing of the fish, such as cleaning and filleting.

The reader will understand that the discovery of the problems to be solved, as well as the solution to those problems, can constitute invention. In so far as the problems set forth have not been discussed or suggested in the prior art, invention is claimed. In what follows, I set forth the accumulations of the problems that have lead me to my discovery.

During filleting of fish or the processing of small game, the process the accumulation of fluids, blood, internal and external parts (such scales, etc) are always left standing on the working surface creating an unsafe working environment with the possibilities of cutting or stabbing oneself while trying to hold both the fillet board and the fish or game in position at the same time.

Further, the fillet boards are designed to be placed in a horizontal position requiring a flat working surface such as a table or a counter top. This flat position is where the fluids and unwanted body parts will always lay in the way causing a very slick, messy, unsanitary, and undesirable working area. In this position there is a problem with cleanliness where the hair, scales, body fluids etc. are in constant contact with the finished product. This not only creates more steps for the user by having to further process and clean the final product but also adds the element of germs and or disease to be in contact with the final product.

The units that are in use today incorporate various types of clamping and/or holding devices to hold the fish in place. These clamping or holding devices rarely work effectively. This is due to the holding units being too weak. Further, the fluids encountered in the cleaning process create slick, detrimentally lubricated, working conditions which render the clamping device ineffective. The product usually ends up slipping from the cleaning surface onto the floor or the ground. Contamination can occur.

Further, and during these disabilities, it will be remembered that the user is trying to control the slippery fish or small game with a sharp knife in his hand. The units in use today are also designed for smaller fish and are not designed for use with small game.

### BRIEF SUMMARY OF THE INVENTION

A filleting apparatus and process depending spends a fish and/or small game by the tail and/or head and legs along an inclined supporting surface. A fillet board having a supporting surface is elongated along a major axis has the supporting surface extending across the length of the fillet board parallel to a minor axis of the fillet board taken normal to the major axis of the fillet board. A loop is mounted at one of the fillet board approximate the major axis for suspending the fish by the tail or the small game by the head or legs. Apparatus supports the fillet board with the supporting surface upwardly exposed and the major axis in an inclined disposition. The loop is at the upper end of the inclined fillet board, the supported fillet board having the fish and/or small game supporting surface horizontally disposed relative to the minor axis when the fillet board is in the inclined disposition. The fish and/or small game when suspended at the tail at the upper end of the fillet board from the loop disposes the body of the fish and/or small game along the supporting surface with the major axis of the fillet board depending downwardly from the loop. Processing of the fish and/or small game can occur with support of the body across the fillet board along the minor axis whereby the fish and/or small game is supported for cleaning and filleting.

In the preferred embodiment, the disclosed vertical freestanding fillet board has a first frame member and a second frame member. The second frame member is significantly shorter than the first frame member and slightly narrower than the first frame member. The second frame member folds to a position within the confines of the first frame member to provide a thin, compact, easily stored fillet board for use either in and around the home or on a fishing or hunting trip.

The first frame member includes a notch, cut in at the top center to receive a section of rope that is tied in a slip knot. The rope simply and easily is slipped around the fishes tail or the head, legs and/or tail of the small game animal and then the rope is dropped in the slot where the actual knot prevents the rope securing the fish or game to be cleaned from sliding out, thus holding it very securely in place.

The first frame member and the second frame member both include a hole cut in a rectangular fashion near the center and close to one edge which align with one another when the vertical freestanding fillet board is in the closed position forming a convenient handle for carrying.

The first frame member can be provided with an optional knife sharpener at the top allowing for quick and easy access for conveniently sharpening the fillet knife which is very important during the processing of fish fowl and small game.

The first frame member and the second frame member both have a large wedge shape cut from the bottom end forming four points or legs which the vertical freestanding fillet board will stand on when in the open, upright position to allow for a secure, sturdy base when set up on a flat surface as well as an uneven, rocky surface.

It is therefore an object of the invention to provide a fillet board that is freestanding in an upright vertical position both in the field and on regular surfaces.

It is another object of the invention to provide a fillet board that will accommodate large fish and small game other than fish.

It is another object of the invention to provide a fillet board that incorporates a secure hands free and convenient means of holding the fish or small game in position.

It is another object of the invention to provide a fillet board that will fold up for convenient storage and/or transport, especially to and from the field.

It is another object of the invention to provide a fillet board that will allow for internal storage of the basic essentials for processing fish, small game and fowl such as a fillet knife, plastic bags, fish scalier, and the like.

It is another object of the invention to provide a fillet board that can accommodate a built in knife sharpener.

It is another object of the invention to provide a fillet board that has a built in measuring device for measuring the fish.

### BRIEF DESCRIPTION OF THE DRAWINGS

FIG. 1 is a perspective view of the A-frame supported fillet board having the A-frame support opened to expose an implement compartment, here shown, containing a fish suspending rope and the cleaning knife;

FIG. 2 is an enlarged view of the fillet board at the upper inclined end with the rope within the rope suspending notch and the rope looped around the tail of a fish preparatory to processing; and,

FIG. 3 illustrates a standing adult processing a fish here illustrating the fish having been cleaned on the board and being filleted along that the right side with support of the fish body at the left side along the fish supporting surface of the fillet board.

### DETAILED DESCRIPTION OF THE INVENTION

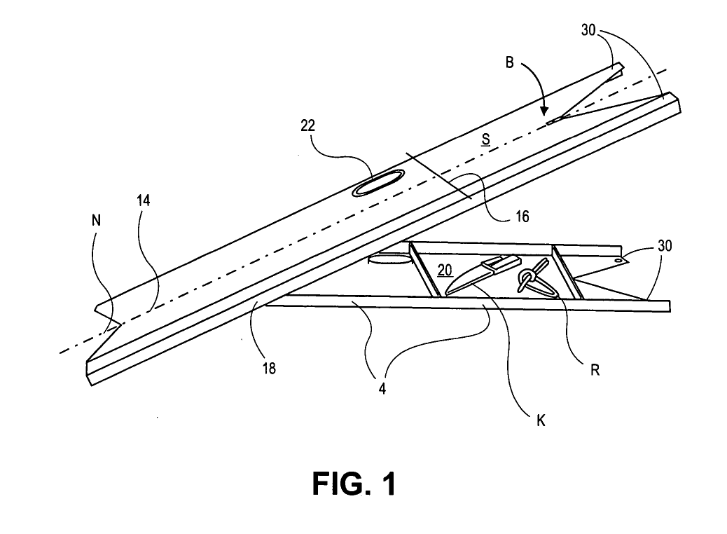

Referring to FIG. 1, filleting board B having a fish supporting surface S is illustrated. The board B is elongate along the major axis 14, generally rectilinear in shape, and defines fish supporting surface parallel to minor axis 16, which is here shown running through handhold 22. Hinge 18 allows A-frame A to pivoted outwardly from a confronting positioned in interior of filleting board B. The A-frame A includes compartment 20 which is here shown containing rope R and knife K. Notch N is at one end of board B; the opposite end of board B and A-frame are provided with V-shaped legs 30 which prove ideal for supporting filleting board B on irregular surfaces, such as the gravel covered surface typical to most remote riverbanks. The construction here shown is of hollow, U-shaped sheet metal. Other materials and forms of construction will do as well. For example, I have constructed prototypes of this invention utilizing wood.

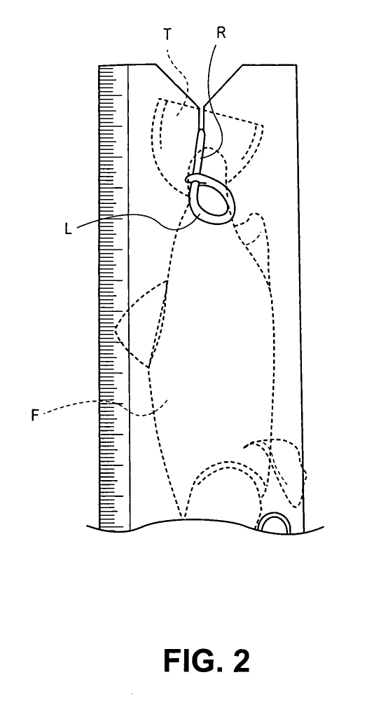

Referring to FIG. 2, rope R is shown formed into a loop L, which loop is passed around tail T of fish F. A knot (not shown) suspends rope R within notch N. It can be easily understood that fish F can be held at tail T from notch N.

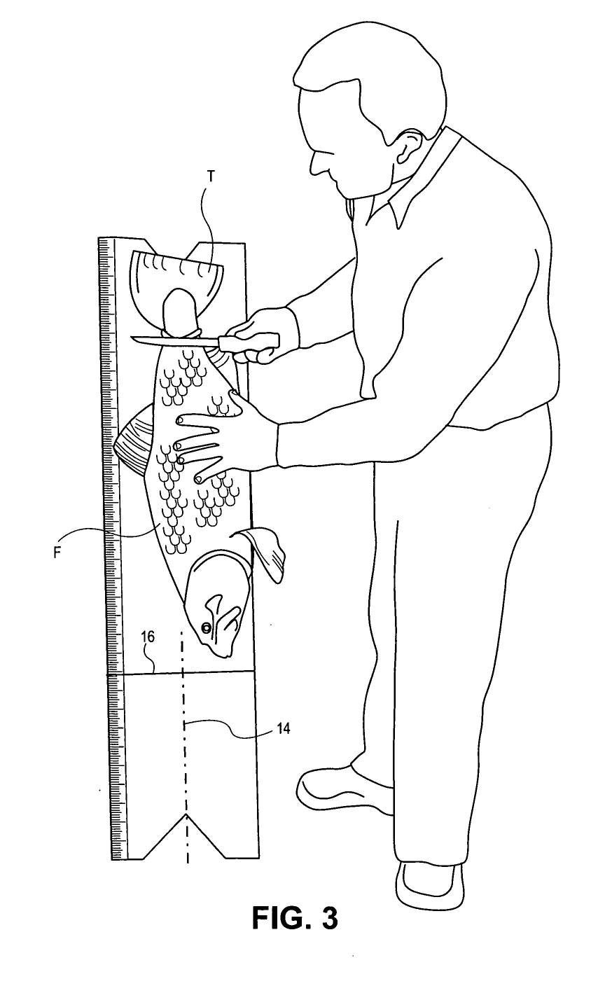

Referring to FIG. 3, operation of the filleting board B can be easily understood. In the usual case, fish F will be placed on fish supporting surface S and the board supported in an inclined disposition so that major axis 14 inclines downwardly from rope R. Regarding the downward inclination, I prefer and inclination to exceeds 45 degrees. The inclination can be 60 degrees, and in a preferred embodiment at has an inclination of about 75 degrees. The preferred and steep inclination of 75 degrees enables the fish to be easily maneuvered from right side to left side as well as to maintain a firm positioned on the board B during cleaning, where the forces of the knife in cleaning implement tended to move that fish away and along the board.

When the board is held in the inclined disposition, it is important that its minor axis 16 be disposed substantially horizontally. Otherwise, fish F would tend to move to one side or the other of fish supporting surface S.

Processing is simple. First the board B is opened and is illustrated in FIG. 1. Thereafter, it is directed a shown in FIG. 3. Finally, fish F is supported by rope R and loop L with the bitter end of the rope R placed within notch N. Filleting occurs from the tail to end towards the head in the usual case.

1. A fish and/or small game processing apparatus dependingly suspends a fish and/or small along an inclined supporting surface, the processing apparatus comprising in combination:
a fillet board having a supporting surface elongated along a major axis and the supporting surface extending across the length of the fillet board parallel to a minor axis normal to the major axis;
a loop mounted at one of the fillet board approximate the major axis for suspending the fish and/or small game by an appendage;
apparatus for supporting the fillet board with the supporting surface upwardly exposed and the major axis in an inclined disposition with the loop at the upper end of the inclined fillet board, the supported fillet board having the supporting surface horizontally disposed relative to the minor axis when the fillet board is in the inclined disposition;
whereby the fish and/or small game when suspended at the tail at the upper end of the fillet board from the loop disposes the body of the fish and/or small game along the major axis of the fillet board depending downwardly from the loop for support across the fillet board along the minor axis whereby the fish and/or small game is supported for processing.

2. The fish and/or small game supporting apparatus of claim 1 and wherein:
the apparatus for supporting the fillet board in the inclined disposition is an A-frame.

3. The fish and/or small game supporting apparatus of claim 1 and wherein:
the fillet board is a hollow sheet metal construction.

4. The fish and/or small game supporting apparatus of claim 1 and wherein:
the fillet board defines a compartment for containing tools.

5. The fish and/or small game supporting apparatus of claim 2 and wherein:
the A-frame is hinged to the fillet board.

6. The fish and/or small game supporting apparatus of claim 5 and wherein:
the A-frame opens at a fixed angle relative to the fillet board.

7. The fish and/or small game supporting apparatus of claim 1 and wherein:
the loop is a rope.

8. The fish and/or small game supporting apparatus of claim 7 and wherein:
the rope fastens to the fillet board at a notch.

9. The fish and/or small game supporting apparatus of claim 1 and wherein:
the inclined disposition of the major axis exceeds 45 degrees.

10. The fish and/or small game supporting apparatus of claim 9 and wherein:
the inclined disposition of the major axis exceeds 60 degrees.

11. The fish and/or small game supporting apparatus of claim 10 and wherein:
the inclined disposition of the major axis is 75 degrees or greater.

12. A fish and/or small game processing technique comprising the steps of:
providing a fillet board having a supporting surface elongated along a major axis and the supporting surface extending across the length of the fillet board parallel to a minor axis normal to the major axis;
providing a loop mounted at one of the fillet board approximate the major axis for suspending the fish and/or small game by an appendage;
supporting the fillet board with the supporting surface upwardly exposed and the major axis in an inclined disposition with the loop at the upper end of the inclined fillet board, the supported fillet board having the supporting surface horizontally disposed relative to the minor axis when the fillet board is in the inclined disposition;
suspending a fish and/or small game at the tail at the upper end of the fillet board from the loop to dispose the body of the fish and/or small game along the major axis of the fillet board depending downwardly from the loop for support across the fillet board along the minor axis; and,
processing from the appendage towards the lower part of the fish or small game to maintain the fish and/or small game on the supporting surface during processing.

13. The fish and/or small game processing technique according to claim 12 comprising the further steps of:
cleaning the fish and/or small game from the tail towards the bottom of the supporting surface.

14. The fish and/or small game processing technique according to claim 12 comprising the further steps of:
filleting a fish from the tail towards the head.

15. The fish and/or small game processing technique according to claim 12 wherein the step of supporting their fillet board includes:
providing an A-frame hinged to the processing surface; and,
opening the A-frame to support to the processing surface in an angularly inclined disposition.

16. The fish and/or small game processing technique according to claim 12 comprising the further steps of:
providing a rectilinear fillet board.
